(19) United States
(12) Patent Application Publication
(10) Pub. No.: US 2005/0236723 A1
(43) Pub. Date: Oct. 27, 2005

(54) Natural vaporization humidifier

(76) Inventor: Man Hi Lee, Yougin-si (KR)

Correspondence Address: Bryan A. Santarelli;Suite 350, 155-108th Avenue N.E., Bellevue, WA, 98004-5904, US

(21) Appl. No.: 11/172,167

(22) Filed: Jun. 29, 2005

Related U.S. Application Data
(63) Continuation-in-part of application No. 10/859,719, filed on May 28, 2004.
Application No. 10/859,719 is a continuation of application No. PCT/KR02/02209, filed on Nov. 26, 2002.

(30) Foreign Application Priority Data
Dec. 1, 2001 (KR) 2001-75729

(51) Int. Cl. B01F 3/04

(52) U.S. Cl. 261/104; 261/DIG. 65

(57) ABSTRACT

A natural vaporization humidifier using latent heat of water evaporation is provided. The humidifier comprising a water reservoir capable of containing water; a basin having an upper area that the water reservoir is installed thereon, and receiving water from the water reservoir and containing the water therein at a predetermined water level; at least one elongated conduit formed integrally with the basin, each conduit having the same water level as the basin in order to receive the water from the basin at the predetermined water level; a vaporizing plate cartridge including a plurality of upright vaporizing plates, the vaporizing plate being arranged at an equal distance (d) on the conduit to the longitudinal direction of the conduit, each vaporizing plate having at least one protrusion correspondingly coupled with the conduit on parts of lower ends thereof, wherein the protrusion is drowned in the conduit so that the vaporizing plate can absorb the water through the protrusion from the conduit, wherein the vaporizing plate cartridge is wider than the conduit so that the lower ends of the vaporizing plate except the protrusion is open to the ground; and a holder for supporting the basin and the conduit spaced apart from the ground by a predetermined distance to accelerate an downward air flow between the vaporizing plates, wherein the average ratio of height (H) of the vaporizing plate to the distance (d) between each vaporizing plate is within the range of 14.6:1˜17.4:1. Thus, natural convection of the air is performed through the airflow spaces defined between the vaporizing plates of the vaporizing plate cartridge. Accordingly, humidification performance of the humidifier can be greatly improved.

### CROSS-REFERENCE TO RELATED APPLICATIONS

This is a continuation-in-part application that claims benefit under 35 USC §120 of co-pending U.S. Continuation application Ser. No. 10/859,719 filed 28 May 2004, which claims priority under 35 USC §120 from International Application PCT/KR02/02209, filed 26 Nov. 2002, designating the United States, which claims foreign priority benefits under 35 USC §119(a) to Korean Patent Application No. 2001-75729, filed 1 Dec. 2001, which applications are all incorporated herein by this reference.

### TECHNICAL FIELD

The present invention relates to a humidifier, and more particularly, to a natural vaporization humidifier capable of enhancing its humidification capacity using latent heat of water evaporation.

### BACKGROUND ART

In order to control room humidity, an electric humidifier is widely used in general home, hospital, office and the like. However, such an electric humidifier generally causes water to be splashed with ultrasonic waves or a fan to be rotated in order to perform forced humidification. Therefore, there are some problems in that noise is generated from the electric humidifier upon rotation of the fan, and an environment in which molds, harmful germs and the like can be propagated are established due to excessive moisture generated by the forced humidification.

Accordingly, a natural vaporization humidifier employing a natural vaporization mode has been recently used. Korean Laid-Open Utility Model Registration Publication No. 1994-13102 discloses an example of a technique of such a natural vaporization humidifier. FIG. 1 is a perspective view of the natural vaporization humidifier which is disclosed in Korean Laid-Open Utility Model Registration Publication No. 1994-13102.

As shown in FIG. 1, the conventional natural vaporization humidifier 100 comprises a basin 110 for containing water therein, a pair of adaptors 120 installed on the basin 110 at a predetermined interval, and a plurality of Korean papers 130 which are installed side by side such that one sides thereof are installed at the pair of adaptors 120 and other sides thereof are immersed in the water contained in the basin 110. That is, the natural vaporization humidifier 100 is constructed such that the water contained in the basin 110 is absorbed into and then naturally vaporized from the respective papers 130 so as to perform the humidification. However, such a natural vaporization humidifier 100 has a disadvantage in that vaporization efficiency is reduced because air cooled down during the vaporization of the moisture cannot further descend below the basin 110 due to blockage of the basin.

In addition to such a natural vaporization humidifier 100, various technologies for the natural vaporization humidifier have been widely known in the art. Such known technologies include Korean Laid-Open Utility Model Registration Publication Nos. 1994-24234 and 1996-18294, Japanese Laid-Open Utility Model Registration Publication Nos. (Sho) 54-107962 and (Sho) 61-169317, and Japanese Laid-Open Patent Publication No. (Hei) 2-192527.

According to the aforementioned known technologies, the natural vaporization humidification is performed through respective vaporizing cloths of which one sides are fixed to the adaptor and other sides are immersed in the water contained in the basin. That is, according to the known technologies, at least one or more vaporizing cloths are installed in the single basin so as to perform the natural humidification. Thus, the natural vaporization humidifier performing the humidification through a sheet of the vaporizing cloth has a reduced humidification effect because of a small vaporization area thereof. On the other hand, the natural vaporization humidifier in which a plurality of vaporizing cloths are arranged has an increased vaporization area because several sheets of the cloths are used. However, there is another disadvantage in that humidification capability thereof is deteriorated since the air cannot flow downwardly through but stagnates between the vaporizing cloths.

The humidification capability of the natural vaporization humidifier greatly depends on the vaporization area of the vaporizing cloths and a natural convection phenomenon occurring therein. Although such known technologies tries to cause the vaporization area to be increased by employing the plurality of vaporizing cloths therein, they are not still constructed in such an extent that the sufficient smooth natural convection can be sufficiently performed.

In order to solve the aforementioned problems in the prior arts, therefore, the applicant has developed a natural vaporization humidifier disclosed in Korean Patent No. 10-295780. FIG. 2 is a perspective view of the natural vaporization humidifier disclosed in Korean Patent No. 10-295780.

As shown in FIG. 2, the conventional natural vaporization humidifier 200 comprises a basin 210 for containing water therein; a plurality of conduits 220 which are installed side by side at a predetermined interval for communicating with the basin 210; a water reservoir 230 for supplying the water to the basin 210 and the conduits 230 up to a predetermined water level thereof; an adaptor 240 installed for causing hangers 241 to be positioned above the conduits 220, respectively; and a plurality of vaporizing cloths 250 installed such that one sides thereof are hung from above the hangers 241 and other sides thereof are immersed in the water filled in the conduits 220. That is, according to the natural vaporization humidifier 200, the vaporization area thereof is increased by the plurality of vaporizing cloths 250 installed side by side. Further, since the plurality of vaporizing cloths are installed at a predetermined height above the ground and at the interval among them, the air cooled down by the moisture vaporization can smoothly descend in a natural convection mode. Thus, there is an advantage in that the humidification capability can be enhanced.

However, since the conduits 220 corresponding to the number of the vaporizing cloths 250 to be arranged should be installed to communicate with the basin 210 within the natural vaporization humidifier 200, there are disadvantages in the size of the humidifier becomes larger and the constitution thereof becomes complicated. Furthermore, since an additional adaptor should be used in the natural vaporization humidifier 200 due to use of the vaporizing cloths incapable of standing upright, the constitution thereof becomes more complex.

### DISCLOSURE OF INVENTION

Accordingly, the present invention is conceived to solve the above problems in the prior arts. It is an object of the present invention to provide a natural vaporization humidifier wherein simplified constitution and enhanced humidification effect thereof can be achieved by installing a plurality of upright vaporizing cloths on conduits formed to communicate with a basin.

According to an aspect of the present invention for achieving the object, there is provided a natural vaporization humidifier, which comprises a water reservoir capable of containing water; a basin having an upper area that the water reservoir is installed thereon, and receiving water from the water reservoir and containing the water therein at a predetermined water level; at least one elongated conduit formed integrally with the basin, each conduit having the same water level as the basin in order to receive the water from the basin at the predetermined water level; a vaporizing plate cartridge including a plurality of upright vaporizing plates, the vaporizing plate being arranged at an equal distance (d) on the conduit to the longitudinal direction of the conduit, each vaporizing plate having at least one protrusion correspondingly coupled with the conduit on parts of lower ends thereof, wherein the protrusion is drowned in the conduit so that the vaporizing plate can absorb the water through the protrusion from the conduit, wherein the vaporizing plate cartridge is wider than the conduit so that the lower ends of the vaporizing plate except the protrusion is open to the ground; and a holder for supporting the basin and the conduit spaced apart from the ground by a predetermined distance to accelerate an downward air flow between the vaporizing plates, wherein the average ratio of height (H) of the vaporizing plate to the distance (d) between each vaporizing plate is within the range of 14.6:1˜17.4:1.

### BRIEF DESCRIPTION OF DRAWINGS

FIG. 1 is a perspective view showing an example of a conventional humidifier.

FIG. 2 is a perspective view showing another example of the conventional humidifier.

FIG. 3 is an exploded perspective view showing the configuration of a natural vaporization humidifier according to a preferred embodiment of the present invention.

FIG. 4 is an exploded perspective view showing the configuration of a vaporizing plate cartridge shown in FIG. 3.

FIG. 5 is a partial detailed view showing the configuration of the vapor paper shown in FIG. 4.

FIG. 6 is a respective view showing an assembled state of the natural vaporization humidifier shown in FIG. 3.

FIG. 7 is a perspective view explaining a height (H) and a width (W) of the vaporizing plate as shown in the FIG. 3.

FIG. 8 is a table that shows a laboratory test as an Experimental Example I for the humidifier according to the present invention.

FIG. 9 is a graph that shows the result of the FIG. 8.

FIG. 10 is a graph that shows a test result of an Experimental Example II for the humidifier according to the present invention.

FIG. 11 is an exploded perspective view showing the configuration of a natural vaporization humidifier according to another preferred embodiment of the present invention.

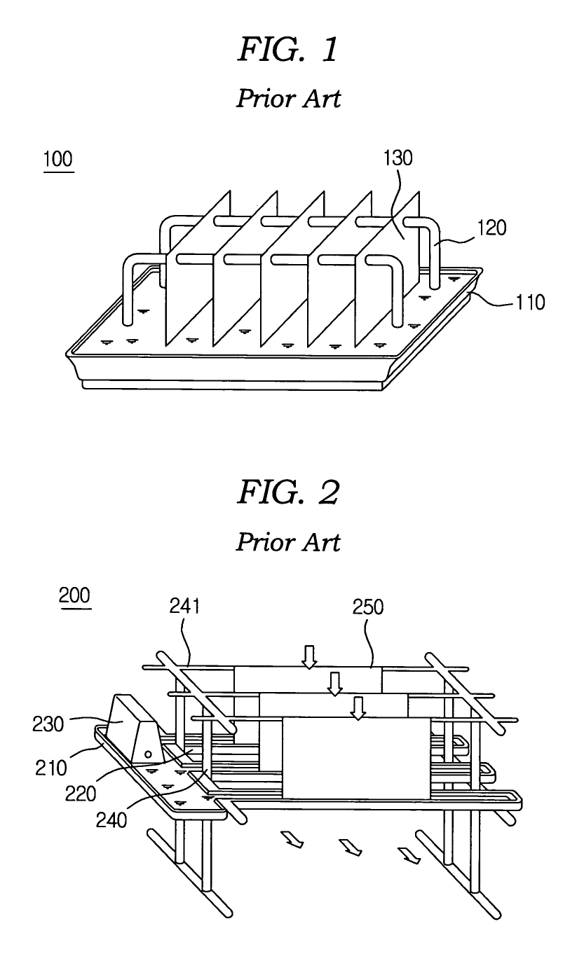

### BEST MODE FOR CARRYING OUT THE INVENTION

Hereinafter, preferred embodiments of a natural vaporization humidifier according to the present invention will be explained with reference to the accompanying drawings.

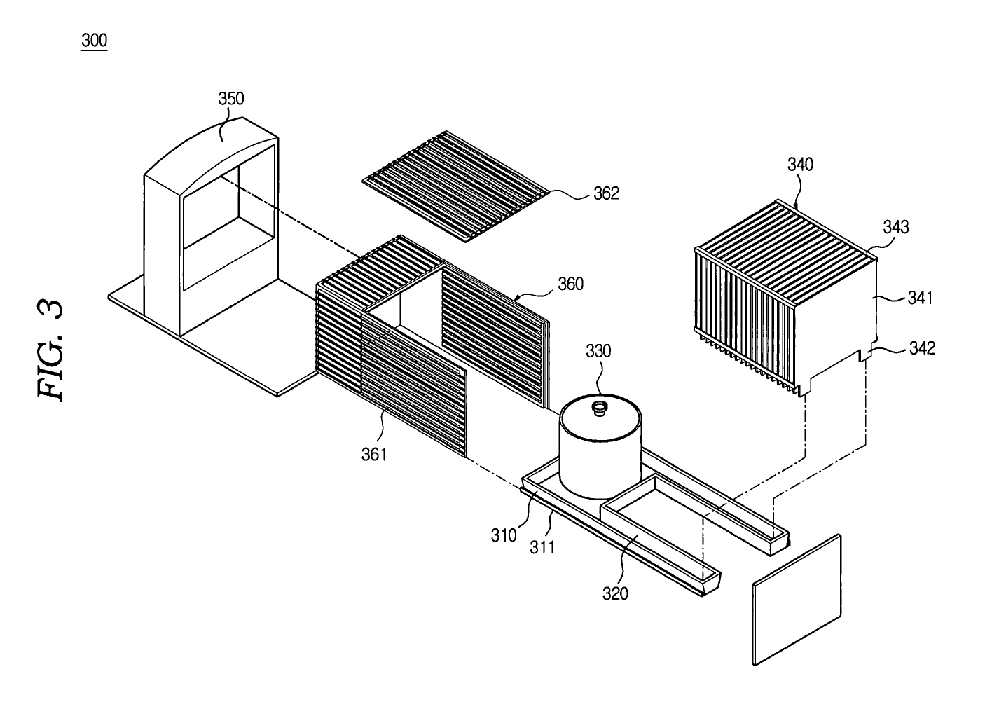

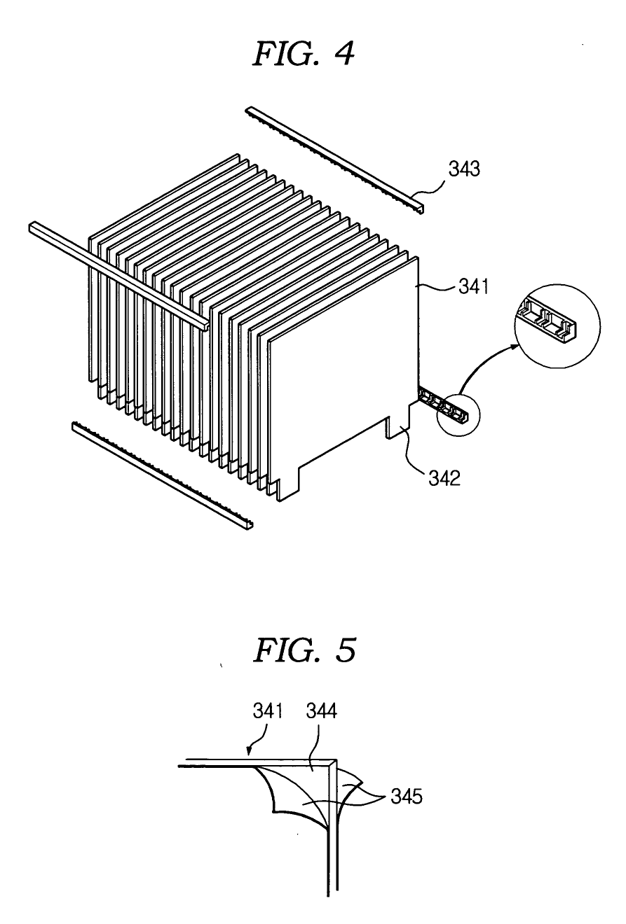

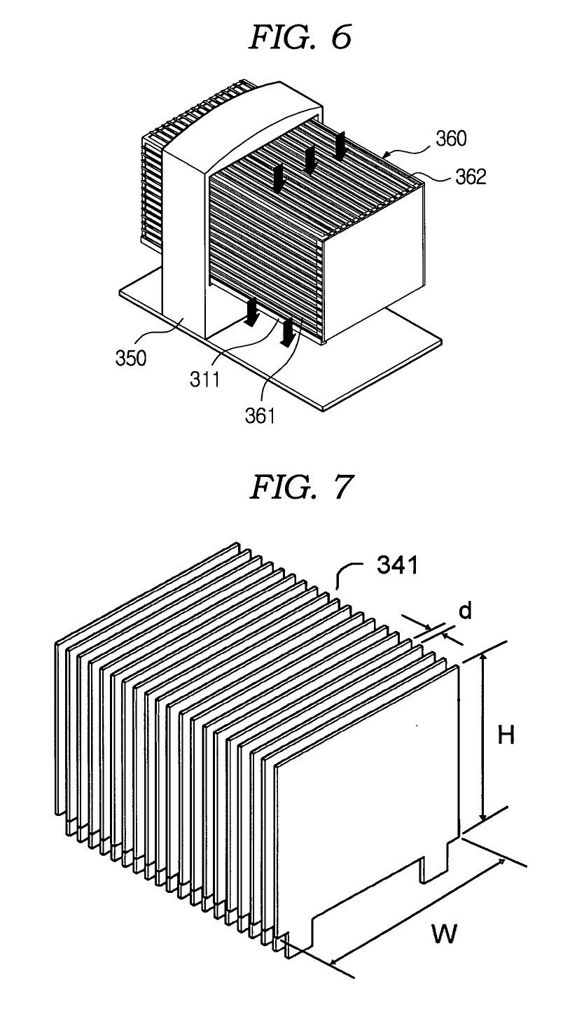

FIG. 3 is an exploded perspective view showing the constitution of the natural vaporization humidifier according to a preferred embodiment of the present invention; FIG. 4 is an exploded perspective view showing the constitution of a vaporizing plate cartridge shown in FIG. 3; FIG. 5 is a detailed view of showing the partial constitution of a vaporizing cloth shown in FIG. 4; and FIG. 6 is a perspective view showing an assembled state of the natural vaporization humidifier shown in FIG. 3.

As shown in FIGS. 3 to 6, the natural vaporization humidifier 300 of the present invention comprises a basin 310 for containing water therein; a pair of conduits 320 which are formed to communicate with the basin 310 and arranged at a predetermined interval; a water reservoir 330 for supplying the water to the basin 310 and the conduits 320 up to a predetermined water level thereof; a vaporizing plate cartridge 340 which is installed across the pair of conduits 320 and includes a plurality of vaporizing plates of which side portions of one ends are directly inserted into the pair of conduits 320, respectively; a holder 350 for supporting the basin 310 and the conduits 320 in a state where the basin and conduits are spaced apart from the ground by a predetermined distance and a space defined between the pair of conduits 320 faces toward the ground; and a porous housing 360 for covering the basin 310, the conduits 320, the water reservoir 330, and the vaporizing plate cartridge 340 so as to define an external appearance of the natural vaporization humidifier.

As shown in FIG. 3, the basin 310 is sized to have an area to such an extent that the water reservoir 330 can be installed therein, and a depth to such an extent that a certain level of water can be contained therein. Further, the pair of conduits 320 are formed at opposite ends of one side of the basin 310 to extend from the opposite ends, respectively. Each of the conduits 320 is shaped to be narrow and elongated, and has the same depth as the basin. That is, the pair of conduits 320 are arranged at a predetermined distance, and thus, a certain sized space is defined between the conduits.

The water reservoir 330 is a very general device that is used in most humidifier and is constructed to supply the water contained in a water tank thereof to the basin 310 and the conduits 320 up to the predetermined water level. The detailed descriptions about the structure and/or the function of the device 330 are omitted from this specification because the structure and function of the device 330 are disclosed in a conventional art.

As shown in FIG. 4, the vaporizing plate cartridge 340 comprises a plurality of upright vaporizing plates 341 each of which has a pair of downward protrusions 342 formed at the opposite side positions of a lower end of the vaporizing plate, and connection strips 343 for allowing the vaporizing plates 341 arranged at an equal interval to be connected with one another. At this time, the pair of downward protrusions 342 formed at the lower end of the vaporizing plate are formed to correspond to and to be inserted into the pair of conduits 320, respectively. That is, the vaporizing plate cartridge 340 is constructed in such a manner that the plurality of vaporizing plates 341 are first arranged at the equal interval and the connection strips are then attached to the plates with an adhesive. In addition, if the vaporizing plates 341 can be connected with one another by using the connection strips 343, any other means than the adhesive may be utilized. It is preferred that connection strips in which a plurality of coupling grooves for allowing the plurality of the vaporizing plates 341 to be inserted thereinto and connected with one another are formed be used as the connection strips 343. The vaporizing plate cartridge 340 constructed as such is sized to correspond to the whole conduits 320. Therefore, if the vaporizing plate cartridge 340 is placed onto the conduits 320, the downward protrusions 342 of the vaporizing plates 341 are inserted into the conduits 320 and the vaporizing plate cartridge is consequently maintained at its upright state.

As shown in FIG. 5, each of the vaporizing plates 341 is constructed in such a manner that materials capable of absorbing the water are attached to opposite sides of a material (plastic, wood or the like) with certain rigidity sufficient for allowing itself to stand upright. Preferably, as shown in FIG. 5, the vaporizing plate 341 comprises woodrock 344 with the certain rigidity for allowing itself to stand upright and water-absorbable nonwoven fabrics 345 attached to opposite sides of the woodrock 344.

Furthermore, the holder 350 supports the basin 310 and the conduits 320 so that they are placed to be spaced apart from the ground by the predetermined distance and the space defined between the conduits 320 is also open to the ground. That is, the holder 350 supports the vaporizing plate cartridge 340 so that the space defined between the conduits 320 or a portion of a bottom face of the vaporizing plate cartridge 340 is open to the ground. Thus, so far as air can smoothly flow between the respective vaporizing plates of the vaporizing plate cartridge 340 installed onto the conduits 320, any kinds of holders may be utilized.

In addition, the porous housing 360 covers the basin 310, the conduits 320, the water reservoir 330, and the vaporizing plate cartridge 340 so as to define an external appearance of the natural vaporization humidifier. The porous housing 360 is placed and installed onto a supporting portion 311 formed on portions of outer edges of the basin 310 and the conduits 320. The porous housing 360 is constructed such that the air can be smoothly supplied to and discharged from the vaporizing plate cartridge 340 installed therein. That is, the porous housing 360 is provided with a plurality of slits 361 which function as airflow passages. Further, a lid 362 is formed on a top portion of the porous housing 360 and is used in exchanging the vaporizing plate cartridge 340 or mounting/demounting the water tank into/from the water reservoir 330 so as to fill the water tank with the water.

According to the humidifier of the present invention, velocity of downward air flow between the vaporizing plates has a direct influence on water evaporation on the vaporizing plate. The humidifier according to the present invention has a structure that there is no obstruction to path of the downward air flow. The water evaporation on the vaporizing plate, which is effected by temperature and humidity, has an influence on lowering the temperature of air between the vaporizing plates. Therefore, the air between the vaporizing plates is heavier than the ambient air and arise downward air flow. Since the amount of water evaporation depends on the ambient temperature and humidity, the downward flow velocity can be adjusted automatically.

According to the natural vaporization humidifier 300 of the present invention constructed as such, since the vaporizing plate cartridge 340 including the plurality of the vaporizing plates 341 is placed onto the pair of conduits 320 communicating with the basin 310, the vaporization area thereof can be increased. Further, since the airflow space is defined between the vaporizing plates of the vaporizing plate cartridge 340, natural convection can be smoothly made. Thus, an improved humidification effect can be obtained. In addition, the air located close to the vaporizing plates is cooled due to the heat of vaporization of naturally evaporating moisture. Then, the cooled air descends since its density is increased. Subsequently, dry air located above the vaporizing plate cartridge also descends and absorbs the moisture. Thus, as mentioned above, natural convection is performed through the airflow spaces defined between the vaporizing plates of the vaporizing plate cartridge 340. Accordingly, humidification performance can be greatly improved.

Hereinafter, an operating principle of the natural vaporization humidifier of the present invention constructed as such will be explained.

The water supplied from the water reservoir 330 is filled into the basin 310 and the conduits 320 to a certain water level. Then, the water is absorbed into the whole vaporizing plates 341 from the downward protrusions 342 of the vaporizing plates of the vaporizing plate cartridge 340 that is installed across the pair of the conduits 320. The moisture evaporates naturally from the vaporizing plates 341 into which the water is absorbed as such. The air located close to the vaporizing plates is cooled due to the heat of vaporization of the naturally evaporating moisture. Then, the cooled air descends since its density is increased. Subsequently, dry air located above the vaporizing plate cartridge also descends, and thus, natural convection humidification can be performed.

### EXPERIMENTAL EXAMPLE I

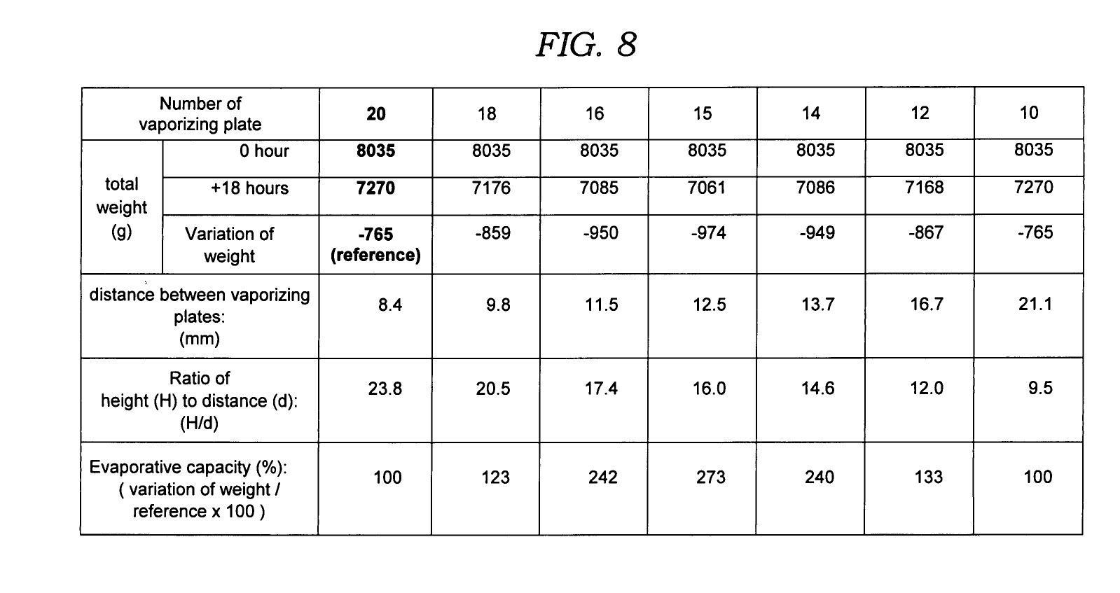

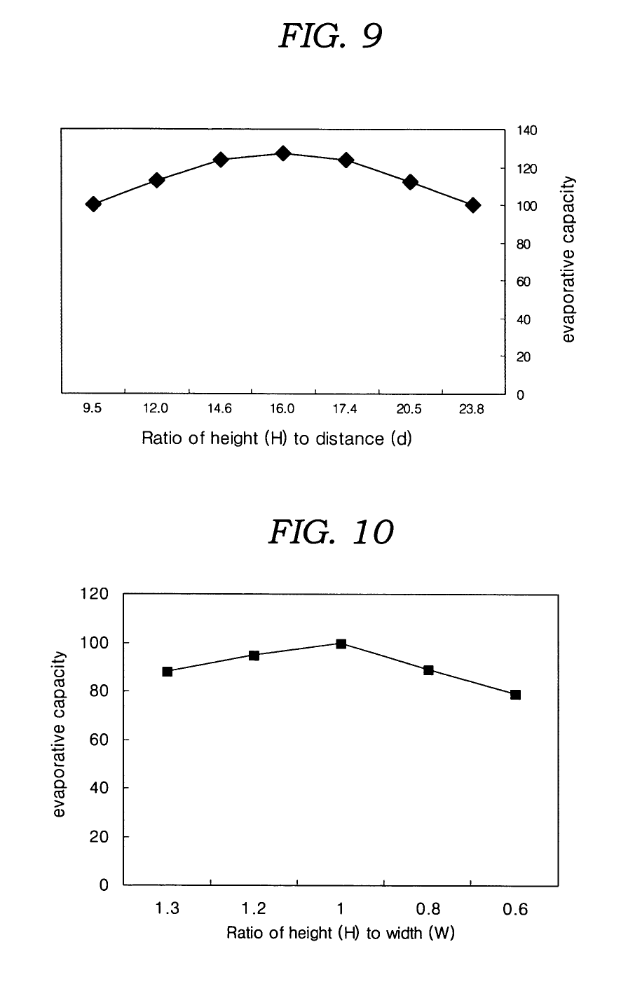

The inventor performed laboratory tests to obtain a preferred span between the vaporizing plates. The vaporizing plate such as FIG. 3 is prepared for the laboratory test. The length of the conduit is 220 mm. A vaporizing plate having a height (H) and width (W) of 200 mm is placed on the conduit at the same distance (d) from each other (See FIG. 7). In each humidifier for the laboratory test, the number of vaporizing plate is 10, 12, 14, 15, 16, 18 and 20. The seven humidifiers are subjected to a room temperature 25° C. with a relative humidity of 35˜60% for 18 hours. Total weight of the humidifier was measured by a digital scale (Model No. SW-1, Manufactured by CAS Inc. located at Sungnae-dong Gangdong-gu Seoul, Republic of Korea) before and after the test. The test result is shown in FIGS. 8 and 9. To compare relative results in evaporative capacity in each humidifier, it was decided that a humidifier having 20 vaporizing plates is a reference for the test.

As shown in FIGS. 8 and 9, the extent of water evaporation of the vaporizing plate depends on the distance (d) between the vaporizing plates. The test results shows that ratio of height (H) to distance (d) between the vaporizing plates from 14.6:1˜17.4:1 has a good evaporation efficiency. Particularly, the best evaporation efficiency occurs in case of the ratio of 16.0:1.

### EXPERIMENTAL EXAMPLE II

To find a preferred width of the vaporizing plate, the width of the vaporizing plate varies with 260 mm, 240 mm, 200 mm and 160 mm, while the distance (d) and height (H) are fixed to d=12.5 mm and H=200 mm, respectively. Total weight of the four humidifiers were measured in the same condition as the Example I. The test result is shown in FIG. 10. To compare relative results of evaporating capacity according to the variation of the width, it was decided to set 200 mm as a reference width for the test.

This test shows that the amount of water evaporation is not much affected by the width (W) as compared with the height (H). However, it is preferable that ratio of height (H) to width (W) is 1:0.6˜1:1.3 in consideration of a good appearance of the humidifier and a product cost of the vaporizing plate.

### Modified Embodiment

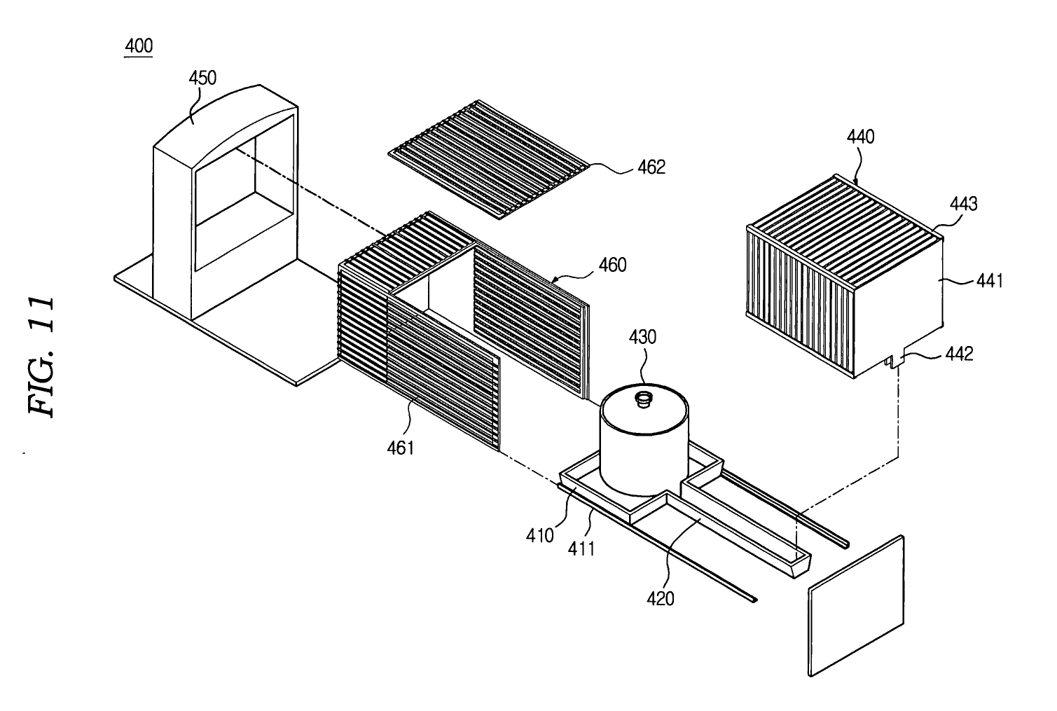

FIG. 11 is an exploded perspective view showing the constitution of a natural vaporization humidifier according to another preferred embodiment of the present invention. As shown in FIG. 11, the natural vaporization humidifier 400 of the present invention is constructed in the same manner as the natural vaporization humidifier 300, except that a single conduit 420 is formed to communicate with a basin 410 for containing the water therein, and that an upright vaporizing plate cartridge 440 is used in such a manner that it is installed over the conduit 420 and central portions at one sides of vaporizing plates 441 thereof are inserted into the conduit 420.

That is, the natural vaporization humidifier 400 of the present invention is constructed in such a manner that downward protrusions 442 are formed at the lower central portions of the vaporizing plates 441 having the same constitution as that shown in FIG. 6, the vaporizing plate cartridge 440 is constructed by connecting these vaporizing plates 441 with connection strips 443 and then installed on the conduits 420, and a water supply device 430, a holder 450 and a porous housing 460 are then coupled with the vaporizing plate cartridge 440 in the same manner as FIG. 3.

As shown in FIGS. 3 and 11, in the natural vaporization humidifier of the present invention, one or two conduits have been formed and the vaporizing plate cartridge has been configured to correspond to the one or two conduits. However, three or more conduits may be formed and the vaporizing plate cartridge may be configured to correspond to the conduits.

As described in detail above, according to the natural vaporization humidifier of the present invention, the vaporization area can be relatively increased by arranging the plurality of vaporizing plates within a small space in a compact manner, and smooth natural convection can be performed by defining the airflow spaces between the vaporizing plates. Thus, there is an advantage in that the humidification performance can be doubled and its structure can also be simplified.

Heretofore, the preferred embodiments of the natural vaporization humidifier according to the present invention have been described with reference to the accompanying drawings. However, they are merely examples of the present invention and do not intend to limit the present invention.

In addition, it will be apparent to those skilled in the art that various modifications or changes can be made thereto without departing from the technical spirit and scope of the invention. Therefore, the appended claims intend to include such various modifications or changes.

1. A natural vaporization humidifier using latent heat of water evaporation, comprising:
a water reservoir capable of containing water;
a basin having an upper area that the water reservoir is installed thereon, and receiving water from the water reservoir;
at least one elongated conduit formed integrally with the basin, the conduit having the same water level as the basin in order to receive the water from the basin;
a vaporizing plate cartridge including a plurality of upright vaporizing plates, the vaporizing plate being arranged at an equal distance (d) on the conduit to the longitudinal direction of the conduit, each vaporizing plate having at least one protrusion correspondingly coupled with the conduit on parts of lower ends thereof, wherein the protrusion is drowned in the conduit so that the vaporizing plate can absorb the water through the protrusion from the conduit, wherein the vaporizing plate cartridge is wider than the conduit so that the lower ends of the vaporizing plate except the protrusion is open to the ground; and
a holder for supporting the basin and the conduit spaced apart from the ground by a predetermined distance to accelerate an downward air flow between the vaporizing plates,
wherein the average ratio of height (H) of the vaporizing plate to the distance (d) between each vaporizing plate is within the range of 14.6:1˜17.4:1.

2. The humidifier as claimed in claim 1, wherein the ratio of height (H) of the vaporizing plate to distance (d) between each vaporizing plate is 16:1.

3. The humidifier as claimed in claim 1, the average ratio of height (H) of the vaporizing plate to width (W) of the vaporizing plate is within the range of 1.3:1˜0.6:1.

4. The humidifier as claimed in claim 1, wherein a pair of the conduits are arranged at a predetermined interval and communicate with the basin, and each of the vaporizing plates includes a pair of the downward protrusions which correspond to the pair of the conduits, respectively.

5. The humidifier as claimed in claim 1, further comprising a porous housing for covering the basin, the at least one conduit, the water reservoir, and the vaporizing plate cartridge and defining an external appearance of the humidifier.

6. The humidifier as claimed in claim 1, wherein the vaporizing plate cartridge is constructed by connecting the plurality of vaporizing plates with connecting strips.

7. The humidifier as claimed in claim 6, wherein each of the vaporizing plates includes plastic plate with certain rigidity sufficient for allowing itself to stand upright and water-absorbable nonwoven fabrics attached to opposite sides of the plastic plate.

8. The humidifier as claimed in claim 4, further comprising a porous housing for covering the basin, the at least one conduit, the water reservoir, and the vaporizing plate cartridge and defining an external appearance of the humidifier.

9. The humidifier as claimed in claim 4, wherein the vaporizing plate cartridge is constructed by connecting the plurality of vaporizing plates with connecting strips.

10. The humidifier as claimed in claim 9, wherein each of the vaporizing plates includes plastic plate with certain rigidity sufficient for allowing itself to stand upright and water-absorbable nonwoven fabrics attached to opposite sides of the plastic plate.
